(19) United States
(12) Patent Application Publication
(10) Pub. No.: US 2026/0303298 A1
(43) Pub. Date: Oct. 1, 2026

(54) OVERLAPPING SUBBAND FULL DUPLEX

(71) Applicant: Lenovo (United States) Inc., Morrisville, NC (US)

(72) Inventor: Khaled Nafez Rauf Ardah, Ilmenau (DE)

(73) Assignee: Lenovo (United States) Inc., Morrisville, NC (US)

(21) Appl. No.: 19/097,181

(22) Filed: Apr. 1, 2025

(51) Int. Cl. H04L 5/00; H04L 5/14

(52) U.S. Cl. CPC H04L 5/0053; H04L 5/14

(57) ABSTRACT

Various aspects of the present disclosure relate to overlapping subband full duplex (SBFD). A user equipment (UE) receives a configuration message that indicates a frequency resource for an overlapping subband in which uplink (UL) and downlink (DL) communications can occur over the frequency resource and a same time resource. The UE concurrently transmits a UL signal and receives a DL signal over the indicated frequency resource.

### TECHNICAL FIELD

The present disclosure relates to wireless communications, and more specifically to overlapping subband full duplex (SBFD).

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration message that indicates a frequency resource for an overlapping subband in which uplink (UL) and downlink (DL) communications can occur over the frequency resource and a same time resource; concurrently transmit a UL signal and receive a DL signal over the indicated frequency resource.

A processor (e.g., a standalone processor chipset, or a component of a UE) for wireless communication is described. The processor may be configured to, capable of, or operable to perform one or more operations as described herein. For example, the processor may be configured to, capable of, or operable to at least one controller coupled with at least one memory and operable to cause the processor to: receive a configuration message that indicates a frequency resource for an overlapping subband in which UL and DL communications can occur over the frequency resource and a same time resource; concurrently transmit a UL signal and receive a DL signal over the indicated frequency resource.

A method performed or performable by a UE for wireless communication is described. The method may include receiving a configuration message that indicates a frequency resource for an overlapping subband in which UL and DL communications can occur over the frequency resource and a same time resource in which UL and DL communications can occur over the frequency resource and a same time resource; and concurrently transmitting a UL signal and receive a DL signal over the indicated frequency resource.

In some implementations of the UE, processor, and method described herein, the configuration message indicates a time resource and a periodicity configuration for the overlapping subband, and to concurrently transmit the UL signal and receive the DL signal, the UE, processor, and method may further be configured to, capable of, performed, performable, or operable to concurrently transmit the UL signal and receive the DL signal over the indicated frequency resource at the indicated periodicity.

In some implementations of the UE, processor, and method described herein, the configuration message indicates a first subband full duplex (SBFD) configuration using the indicated frequency resource, the UE, processor, and method may further be configured to, capable of, performed, performable, or operable to: receive a configuration message that indicates a second SBFD configuration; and receive an indication to use the first SBFD configuration and the second SBFD configuration.

In some implementations of the UE, processor, and method described herein, the configuration message indicates, using at least one of a bitmap or a slot and symbol indication, a time resource for the overlapping subband.

In some implementations of the UE, processor, and method described herein, the configuration message is associated with a predefined configuration or a preconfigured configuration.

In some implementations of the UE, processor, and method described herein, the UE, processor, and method may further be configured to, capable of, performed, performable, or operable to derive at least one of a time resource or a periodicity configuration for the overlapping subband from the predefined configuration or from the preconfigured configuration.

In some implementations of the UE, processor, and method described herein, the configuration message indicates at least one of a time-frequency configuration for a UL non-overlapping subband for UL communications or a time-frequency configuration for a DL non-overlapping subband for DL communications.

In some implementations of the UE, processor, and method described herein, the UE, processor, and method may further be configured to, capable of, performed, performable, or operable to determine that one or more resource blocks (RBs) of the DL non-overlapping subband that overlap one or more RBs of the UL non-overlapping subband are one or more RBs of the overlapping subband.

In some implementations of the UE, processor, and method described herein, the UE, processor, and method may further be configured to, capable of, performed, performable, or operable to determine that one or more RBs of the DL non-overlapping subband that overlap one or more RBs of the UL non-overlapping subband override the one or more RBs of the UL non-overlapping subband.

In some implementations of the UE, processor, and method described herein, the UE, processor, and method may further be configured to, capable of, performed, performable, or operable to determine that one or more RBs of the UL non-overlapping subband that overlap one or more RBs of the DL non-overlapping subband override the one or more RBs of the DL non-overlapping subband.

In some implementations of the UE, processor, and method described herein, to receive the configuration message, the UE, processor, and method may further be configured to, capable of, performed, performable, or operable to receive the configuration message via at least one of a group-specific signaling or a UE-specific signaling.

In some implementations of the UE, processor, and method described herein, the UE, processor, and method may further be configured to, capable of, performed, performable, or operable to determine that one or more RBs of the overlapping subband override one or more RBs of a configured DL subband or a configured UL subband.

An NE (e.g., a base station) for wireless communication is described. The NE may be configured to, capable of, or operable to perform one or more operations as described herein. For example, the NE may be configured to, capable of, or operable to transmit a configuration message that indicates a frequency resource for an overlapping subband in which UL and DL communications can occur over the frequency resource and a same time resource; concurrently receive a UL signal and transmit a DL signal over the indicated frequency resource.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to transmit a configuration message that indicates a frequency resource for an overlapping subband in which UL and DL communications can occur over the frequency resource and a same time resource; concurrently receive a UL signal and transmit a DL signal over the indicated frequency resource.

A method performed or performable by an NE (e.g., a base station) for wireless communication is described. The method may include transmitting a configuration message that indicates a frequency resource for an overlapping subband in which UL and DL communications can occur over the frequency resource and a same time resource; concurrently receiving a UL signal and transmit a DL signal over the indicated frequency resource.

In some implementations of the NE, the processor, and the method described herein, the configuration message indicates a time resource and a periodicity configuration for the overlapping subband, and to concurrently receive the UL signal and transmit the DL signal, the at least one processor is further operable to cause the NE to concurrently receive the UL signal and transmit the DL signal over the indicated frequency resource at the indicated periodicity.

In some implementations of the NE, the processor, and the method described herein, the configuration message indicates a first SBFD configuration using the indicated frequency resource, and the NE, processor, and method may further be configured to, capable of, performed, performable, or operable to: transmit a configuration message that indicates a second SBFD configuration; and transmit an indication to use the first SBFD configuration and the second SBFD configuration.

In some implementations of the NE, the processor, and the method described herein, the configuration message indicates, using at least one of a bitmap or a slot and symbol indication, a time resource for the overlapping subband.

In some implementations of the NE, the processor, and the method described herein, the configuration message is associated with a predefined configuration or a preconfigured configuration.

In some implementations of the NE, the processor, and the method described herein, the configuration message indicates at least one of a time-frequency configuration for a UL non-overlapping subband for UL communications or a time-frequency configuration for a DL non-overlapping subband for DL communications.

In some implementations of the NE, the processor, and the method described herein, one or more RBs of the DL non-overlapping subband that overlap one or more RBs of the UL non-overlapping subband are one or more RBs of the overlapping subband.

In some implementations of the NE, the processor, and the method described herein, one or more RBs of the DL non-overlapping subband that overlap one or more RBs of the UL non-overlapping subband override the one or more RBs of the UL non-overlapping subband.

In some implementations of the NE, the processor, and the method described herein, one or more RBs of the UL non-overlapping subband that overlap one or more RBs of the DL non-overlapping subband override the one or more RBs of the DL non-overlapping subband.

In some implementations of the NE, the processor, and the method described herein, to transmit the configuration message, the NE, processor, and method may further be configured to, capable of, performed, performable, or operable to transmit the configuration message via at least one of a group-specific signaling or a UE-specific signaling.

In some implementations of the NE, the processor, and the method described herein, one or more RBs of the overlapping subband override one or more RBs of a configured DL subband or a configured UL subband.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of an SBFD configuration in accordance with aspects of the present disclosure.

FIG. 4 illustrates an example of a partial overlapping SBFD in accordance with aspects of the present disclosure.

FIG. 5 illustrates an example of an SBFD configuration with an overlapping subband in accordance with aspects of the present disclosure.

FIG. 6 illustrates an example of multiple SBFD configurations in accordance with aspects of the present disclosure.

FIG. 7 illustrates an example of an overlapping subband time resource configuration in accordance with aspects of the present disclosure.

FIG. 8 illustrates an example of multiple bandwidth parts (BWPs) in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

In a new radio (NR) wireless communications system, one or more UEs can communicate with one or more NEs. Communication from an NE to a UE is referred to as downlink (DL) communication, and communication from a UE to an NE is referred to as uplink (UL) communication. Time division duplex (TDD) can be used in NR wireless communications system, which splits the time resources (e.g., symbols and slots) between DL and UL communications. However, the limited allocation of time resources for UL communications in TDD results in reduced UL coverage, reduced UL capacity, and increased UL latency. One technique to overcome these issues is splitting the frequency domain resources of one or more of DL or flexible (F) symbols/slots into non-overlapping DL and UL subbands. However, the UL performance benefits of this technique come, in general, at the cost of reducing the DL performance due to reduced frequency resources for DL communications and the additional inter-UE cross-link interference (CLI) (e.g., the interference observed by a DL UE due to a UL transmission of a nearby UL UE).

To overcome these issues, full and/or partial overlapping SBFD is discussed herein. Full and/or partial overlapping SBFD refers to some of the frequency resources (e.g., partial overlapping SBFD) or all of the frequency resources (e.g., full SBFD), for a given time resource, being jointly shared by DL and UL communications. This joint sharing by DL and UL communications can also be referred to as overlapping (e.g., an overlapping subband) or SBFD. A frequency resource refers to a particular frequency or frequency range, such as a subband (a portion of) of a frequency range supported by the wireless communications system. Jointly sharing or overlapping frequency resources or subbands refers to, for example, a UE concurrently (e.g., using the same time resource) transmitting a UL signal and receiving a DL signal over the same frequency resource or subband, or an NE concurrently (e.g., using the same time resource) receiving a UL signal and transmitting a DL signal over the same frequency resource or subband. An SBFD time-frequency pattern indication framework can be used as a baseline to allocate full and/or partial overlapping SBFD.

Discussed herein are techniques for enabling full and/or partial overlapping SBFD, providing improved flexibility to a network-scheduler (e.g., a NE, such as a gNB) with reduced configuration or indication overhead. For example, an NE can communicate (e.g., transmit, send, signal) a configuration message to the UE that includes a starting slot index and a starting symbol index within the starting slot, as well as an ending slot index and an ending symbol index within the ending slot, for a subband. The same configuration message can further include a resource indication value (RIV) parameter indicating a starting resource block (RB) and a length of RBs for a UL subband, and an RIV parameter indicating a starting RB and a length of RBs for a DL subband. The same configuration message, or a different configuration message, can include an RIV parameter indicating a starting RB and a length of RBs for an overlapping subband.

Accordingly, by enabling full and/or partial overlapping SBFD, the techniques discussed herein allow for improved UL and/or DL performance (e.g., increased UL and/or DL capacity, reduced UL and/or DL latency).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

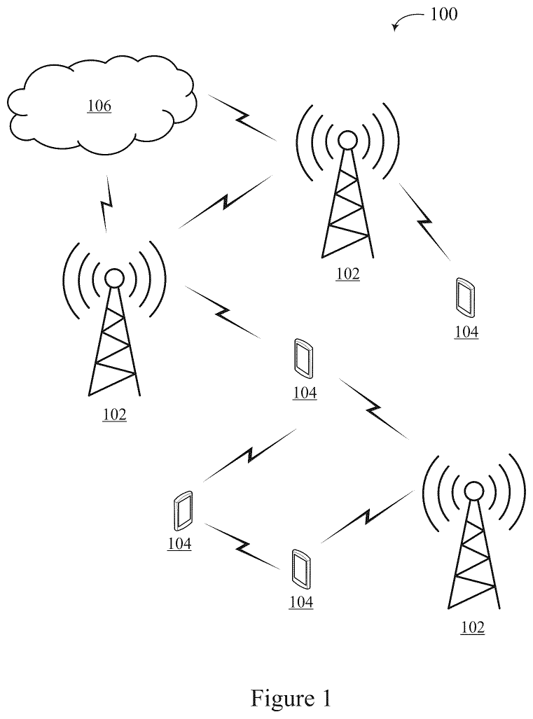

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more NEs 102 configure one or more UEs 104 for SBFD wireless communication. Different UEs 104 can be configured for SBFD wireless communication on the same or different subbands. It should be noted that some UEs 104 may not be configured for SBFD wireless communication, and that UEs can be configured for SBFD wireless communication at different times based on various criteria, such as location, signal strength, type of data to be communicated, and so forth.

In one or more implementations, an NE 102 configures a UE 104 for SBFD wireless communication by communicating (e.g., transmitting, sending, signaling) a configuration (e.g., a configuration message) to the UE 104 indicating one or more of a frequency resource for an overlapping or shared subband, a time resource for the overlapping or shared subband, or a periodicity for the overlapping or shared subband. While performing SBFD, the UE 104 concurrently transmits a UL signal to the NE 102 and receives a DL signal from the NE 102 over the configured resources, and the NE 102 concurrently receives a UL signal from the UE 104 and transmits a DL signal to the UE 104 over the configured resources.

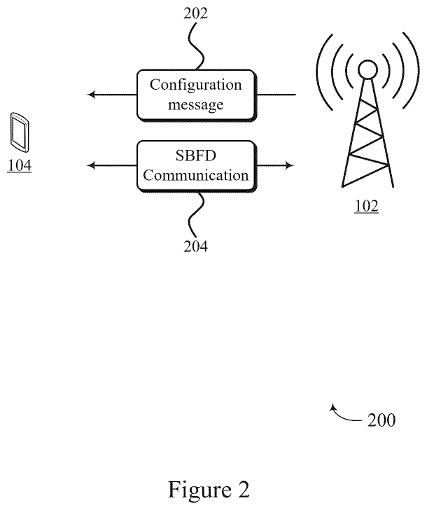

FIG. 2 illustrates an example 200 of wireless communication in accordance with aspects of the present disclosure. In the example 200, an NE 102 communicates (e.g., transmits, sends, signals) a configuration message 202 to a UE 104. The configuration message 202 indicates at least one of a frequency resource for an overlapping or shared subband, a time resource for the overlapping or shared subband, or a periodicity for the overlapping or shared subband. SBFD communication 204 occurs between the UE 104 and the NE 102 based at least in part on the configuration message 202.

Returning to FIG. 1, a slot format includes DL symbols, UL symbols, and flexible symbols. The following are applicable for each serving cell. If a UE 104 is provided tdd-UL-DL-ConfigurationCommon, the UE 104 sets the slot format per slot over a number of slots as indicated by tdd-UL-DL-ConfigurationCommon. The tdd-UL-DL-ConfigurationCommon provides a reference subcarrier spacing (SCS) configuration μ_{ref} by referenceSubcarrierSpacing, and a pattern1. The pattern1 provides a slot configuration period of P msec by dl-UL-TransmissionPeriodicity, a number of slots dₛₗₒₜₛ with only DL symbols by nrofDownlinkSlots, a number of DL symbols d_{sym} by nrofDownlinkSymbols, a number of slots uₛₗₒₜₛ with only UL symbols by nrofUplinkSlots, and a number of UL symbols u_{sym} by nrofUplinkSymbols.

A value P=0.625 msec is valid only for μ_{ref}=3, μ_{ref}=5 or μ_{ref}=6. A value P=1.25 msec is valid only for μ_{ref}=2, μ_{ref}=3, μ_{ref}=5 or μ_{ref}=6. A value P=2.5 msec is valid only for μ_{ref}=1, μ_{ref}=2, μ_{ref}=3, μ_{ref}=5 or μ_{ref}=6. A value P=10 msec is valid only for μ_{ref}=0, μ_{ref}=1, μ_{ref}=2, μ_{ref}=3 or μ_{ref}=5. A slot configuration period of P msec includes S=P·2^{μ}^{_{ref}} slots with SCS configuration μ_{ref}. From the S slots, a first dₛₗₒₜₛ slots include only DL symbols and a last uₛₗₒₜₛ slots include only UL symbols. The d_{sym} symbols after the first dₛₗₒₜₛ slots are DL symbols. The u_{sym} symbols before the last uₛₗₒₜₛ slots are UL symbols. The remaining

$$( S - {d}_{slots} - {u}_{slots} ) \cdot {N}_{symb}^{slot} - {d}_{sym} - {u}_{sym}$$

are flexible symbols. The first symbol every 20/P periods is a first symbol in an even frame.

If tdd-UL-DL-ConfigurationCommon provides both pattern1 and pattern2, the UE 104 sets the slot format per slot over a first number of slots as indicated by pattern1 and the UE 104 sets the slot format per slot over a second number of slots as indicated by pattern2. The pattern2 provides a slot configuration period of P₂ msec by dl-UL-TransmissionPeriodicity, a number of slots d_{slots,2} with only DL symbols by nrofDownlinkSlots, a number of DL symbols d_{sym,2} by nrofDownlinkSymbols, a number of slots u_{slots,2} with only UL symbols by nrofUplinkSlots, and a number of UL symbols u_{sym,2} by nrofUplinkSymbols.

The applicable values of P₂ are same as the applicable values for P. A slot configuration period of P+P₂ msec includes first S=P·2^{μ}^{_{ref}} slots and second S₂=P₂·2^{μ}^{_{ref}} slots. From the S₂ slots, a first d_{slots,2} slots include only DL symbols and a last u_{slots,2} include only UL symbols. The d_{sym,2} symbols after the first d_{slots,2} slots are DL symbols. The u_{sym,2} symbols before the last u_{slots,2} slots are UL symbols. The remaining

$$( {S}_{2} - {d}_{slots , 2} - {u}_{slots , 2} ) \cdot {N}_{symb}^{slot} - {d}_{sym , 2} - {u}_{sym , 2}$$

are flexible symbols. A UE 104 expects that P+P₂ divides 20 milliseconds (msec). The first symbol every 20/(P+P₂) periods is a first symbol in an even frame. A UE 104 expects that the reference SCS configuration μ_{ref} is smaller than or equal to a SCS configuration μ for any configured DL bandwidth part (BWP) or UL BWP. Each slot provided by pattern1 or pattern2 is applicable to 2^{(μ-μ}^{_{ref}}⁾ consecutive slots in the active DL BWP or the active UL BWP where the first slot starts at a same time as a first slot for the reference SCS configuration μ_{ref} and each DL or flexible or UL symbol for the reference SCS configuration μ_{ref} corresponds to 2^{(μ-μ}^{_{ref}}⁾ consecutive DL or flexible or UL symbols for the SCS configuration μ.

For RRC connected mode UEs, at least cell-specific configuration on time and frequency (a working assumption) location of SBFD subbands is supported within a TDD carrier is taken into consideration. Additional support of UE-specific configuration on time and/or frequency locations of SBFD subbands is also taken into consideration.

For RRC connected mode UEs, SBFD subband time period, when only one TDD-UL-DL pattern is configured, the period is the same as TDD-UL-DL pattern period configured by dl-UL-TransmissionPeriodicity in TDD-UL-DL-ConfigCommon is taken into consideration. For RRC connected mode UEs, SBFD subband time period, when two TDD-UL-DL patterns are configured, the period is the same as the sum of the two TDD-UL-DL pattern periods configured by dl-UL-TransmissionPeriodicity in TDD-UL-DL-ConfigCommon is also taken into consideration.

A largest (e.g., the maximum) number of UL subbands for SBFD operation in an SBFD symbol within a TDD carrier is one is taken into consideration. The UL subband can be located at one side of the carrier or can be located at the middle part of the carrier is also taken into consideration. For semi-static indication of SBFD subband frequency location, down-select from the following options is also taken into consideration. Option 1: frequency locations of UL subband and DL subband(s) are explicitly configured. Guardband(s), if any, are implicitly derived as the RBs which are not within UL subband or DL subband(s). Option 2: Frequency location of UL subband and the number of RBs for guardband(s), if any, are explicitly configured. DL subband(s) are implicitly derived as RBs which are not within UL subband or guardband(s).

For cell-specific indication of SBFD subband frequency location, the following option is taken into consideration. Option 1: frequency locations of UL subband and DL subband(s) are explicitly configured. Guardband(s), if any, are implicitly derived as the RBs which are not within UL subband or DL subband(s).

A slot can consist of SBFD symbols and non-SBFD symbols is taken into consideration. For semi-static indication of SBFD subband time location the following is also taken into consideration. When only one TDD-UL-DL pattern is configured, SBFD symbols are configured in consecutive manner within a TDD-UL-DL pattern period. When two TDD-UL-DL patterns are configured and if SBFD symbols are configured for only one of the patterns, SBFD symbols are configured in consecutive manner within the TDD-UL-DL pattern period. When two TDD-UL-DL patterns are configured and if SBFD symbols are configured for both patterns, SBFD symbols are configured in consecutive manner within each TDD-UL-DL pattern period. SBFD symbols are configured in DL and/or flexible symbols configured in TDD-UL-DL-ConfigCommon. The configured SBFD symbols can start from any symbol within a slot and can end in any symbol within a slot. referenceSubcarrierSpacing in TDD-UL-DL-ConfigCommon is used as reference SCS.

The subband frequency-domain resources are same across different SBFD symbols within a TDD carrier is taken into consideration. Frequency location of cell specific UL subband, and DL subband(s) if explicitly indicated, are indicated with reference to common resource block (CRB) grid is also taken into consideration. RB-level granularity is supported for semi-static indication of SBFD subband frequency location is also taken into consideration, subject to guidance on the size of subband/guardband, if any. Reference starting RB and reference SCS is also taken into consideration.

A symbol configured as SBFD symbol via cell-specific configuration cannot be reverted to a non-SBFD symbol via any UE-specific configuration or group-common signaling it taken into consideration. A symbol not configured as SBFD symbol via cell-specific configuration cannot be reverted to an SBFD symbol via any UE-specific configuration or group-common signaling is also taken into consideration.

For cell-specific configuration of frequency locations of SBFD subbands, an Option 1 is taken into consideration in which cell-specific frequency locations of SBFD subbands are separately configured for each SCS configuration in SCS-SpecificCarrierList. For each SCS configuration, the reference starting physical resource block (PRB) is the PRB determined by the SCS configuration and offsetToCarrier corresponding to this subcarrier spacing is also taken into consideration.

For configuration of SBFD symbols within a TDD-UL-DL pattern period, support for the following parameters is taken into consideration: a starting slot index, a starting symbol index within the starting slot, and an ending slot index. An ending symbol index within the ending slot is also taken into consideration.

For cell-specific configuration of frequency locations of SBFD UL subband, for each SCS configuration in SCS-SpecificCarrierList for UL, starting RB and bandwidth of SBFD UL subband are indicated by a RIV-based indication as defined in 38.214 setting

$${N}_{BWP}^{size} = 275$$

is taken into consideration. For cell-specific configuration of frequency locations of SBFD DL subband(s), for each SCS configuration in SCS-SpecificCarrierList for DL, starting RB and bandwidth of each SBFD DL subband are indicated by a RIV-based indication as defined in 38.214 setting

$${N}_{BWP}^{size} = 275$$

is taken into consideration. One or two SBFD DL subbands can be configured is also taken into consideration.

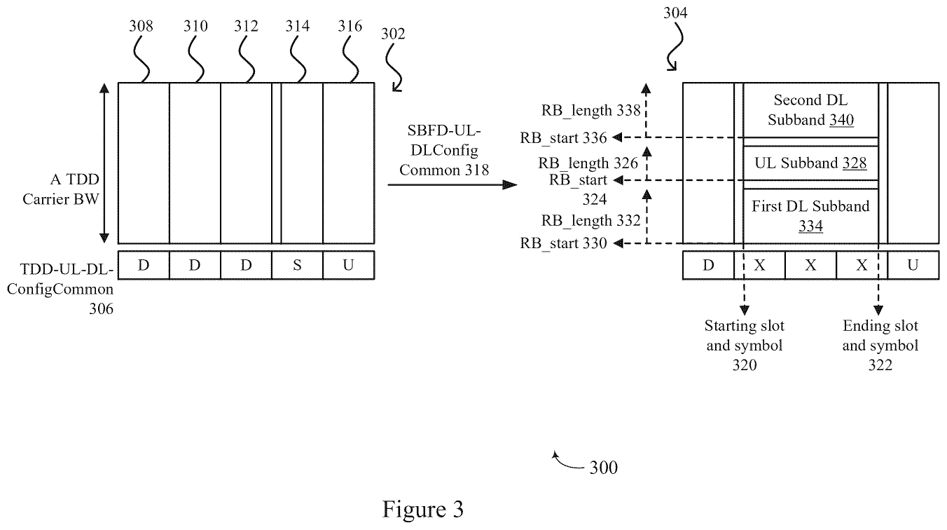

FIG. 3 illustrates an example of an SBFD configuration 300 in accordance with aspects of the present disclosure. One technique to overcome the issues encountered by legacy TDD schemes (e.g., reduced UL coverage and capacity, and increased UL latency) is by splitting the frequency domain resources of one or more of DL and/or flexible (F) symbols/slots into non-overlapping DL and UL subbands, as illustrated by the SBFD configuration 300. This technique increases the time and frequency resources for the UL communications as compared to legacy TDD, which can increase the UL communications capacity and coverage, and reduce the UL communications latency, as compared to legacy TDD-based configuration.

The SBFD configuration 300 illustrates a legacy DDDSU TDD slot configuration pattern 302 reconfigured into a DXXXU SBFD slot configuration pattern 304, where the frequency domain resources of X slots/symbols (also referred to as SBFD slots/symbols) is divided into non-overlapping DL and UL subbands. The TDD-UL-DL-ConfigCommon configuration 306 indicates downlink slots 308, 310, and 312, a switching slot 314, and an uplink slot 316. The TDD slot configuration pattern 302 is reconfigured into a DXXXU SBFD slot configuration pattern 304 via a SBFD-UL-DLConfigCommon configuration 318. The SBFD-UL-DLConfigCommon configuration 318 a time configuration including a starting slot index and a starting symbol index within the starting slot 320, an ending slot index and an ending symbol index within the ending slot 322. The SBFD-UL-DLConfigCommon configuration 318 also includes a frequency configuration including an RIV indicating a starting RB 324 and length 326 of RBs for a UL subband 328, an RIV indicating a starting RB 330 and length 332 of RBs for a first DL subband 334, and optionally an RIV indicating a starting RB 336 and length 338 of RBs for a second DL subband 340.

However, the UL performance benefits achieved using the DXXXU SBFD slot configuration pattern 304 come, in general, at the cost of reducing the DL performance due to reduced frequency resources of DL communications and the additional inter-UE cross-link interference (CLI) (e.g., the interference observed by a DL UE due to a transmission of a nearby UL UE). To overcome this issue, the techniques discussed herein consider full and/or partial overlapping SBFD, where some or all of the frequency resources can be jointly shared by DL and UL communications. Such an approach provides more potential for enhancing not only the UL performance, but also the DL performance. However, the interference power level (e.g., mainly from the self-interference and CLI) observed at the shared resources is, in general, much higher than that at the non-shared resources, e.g., as in the non-overlapping SBFD. Nonetheless, in some deployment and traffic load scenarios, the interference power can be mitigated by using various techniques (e.g., via beam-nulling and advanced receivers), which makes full and/or partial overlapping SBFD approach more resource efficient than non-overlapping SBFD. In other words, in non-overlapping SBFD, self-interference and CLI are mainly handled using passive/avoidance scheme, whereas in full and/or partial overlapping SBFD, self-interference and CLI can be handled using various active schemes (e.g., beam-nulling, advanced receivers, smart resource scheduling, avoidance, or the like).

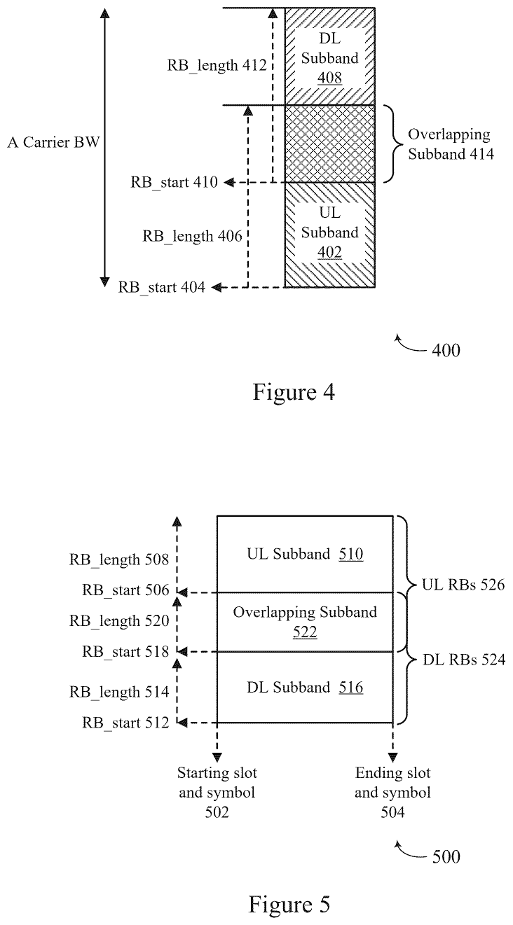

FIG. 4 illustrates an example 400 of a partial overlapping SBFD in accordance with aspects of the present disclosure. The example 400 illustrates a UL subband 402 having a starting RB 404 and length 406, and a DL subband 408 having a starting RB 410 and length 412. An overlapping subband 414 is a subband for joint or shared DL and UL communications. The example 400 uses a time-frequency pattern indication framework (e.g., of Release 19), which provides limited flexibility for the overlapping subband resources location.

The time-frequency pattern indication framework of example 400 can be used to allocate full and/or partial overlapping SBFD (e.g., by indicating a UL and/or a DL subband with a larger RB length). However, with the SBFD time-frequency pattern indication framework of example 400, the subband's frequency-domain resources are the same across different SBFD slots/symbols. Therefore, the SBFD time-frequency pattern indication framework of example 400 has limited flexibility, which is addressed using the techniques discussed below.

FIG. 5 illustrates an example 500 of an SBFD configuration with an overlapping subband in accordance with aspects of the present disclosure. The example 500 illustrates a configuration for a separate sideband for joint DL and UL communications. In accordance with the example 500, UE 104 receives at least one SBFD time-frequency resource configuration message, where the configuration message indicates a time configuration message and a frequency configuration message. The time configuration message includes a starting slot index and a starting symbol index 502 within the starting slot, and an ending slot index and an ending symbol index 504 within the ending slot. The frequency configuration message includes a (e.g., one) RIV indicating the starting RB 506 and the length of RBs 508 for a UL subband 510, a (e.g., one) RIV parameter indicating the starting RB 512 and the length of RBs 514 for a first DL subband 516, optionally a (e.g., one) RIV parameter indicating the starting RB and the length of RBs for a second DL subband (not shown), and a (e.g., one) RIV parameter indicating the starting RB 518 and the length of RBs 520 for an overlapping subband 522. In some examples, one or more of the RIVs within the frequency configuration message are optional. The overlapping subband 522 can also be referred to as a shared subband. The UL subband 510 and the DL subband 516 are not overlapping and thus can also be referred to as non-overlapping subbands or non-shared subbands. Taking into account the overlapping subband 522, the DL RBs 524 and the UL RBs 526 are shown.

In one or more implementations, the UE 104 may receive the overlapping subband time-frequency configurations in a separate message, e.g., via a cell-specific or a group/UE-specific signaling. For example, the UE 104 may receive a non-overlapping SBFD time-frequency configuration message (e.g., to configure the DL subband 516 and the UL subband 510) via a cell-specific signaling (e.g., via SIB1) and then receive an overlapping subband time-frequency configuration message via a group/UE-specific signaling.

In one or more implementations, the time periodicity of overlapping subband time-frequency configurations is the same as (or different than) the time periodicity of the non-overlapping SBFD time-frequency configuration. If different, then the time periodicity of overlapping subband time-frequency configuration is indicated within the configuration message.

In one or more implementations, the time configurations of the overlapping subband are the same as (or different than) the time configurations of the non-overlapping SBFD time configuration. If they are the same, the overlapping subband configuration message may only indicate the frequency configurations, e.g., only the RIV parameter indicating the starting RB 518 and the length of RBs 520 for the overlapping subband 522. Otherwise, the configuration message also indicates the time configurations of the overlapping subband, e.g., a starting slot index and a starting symbol index within the starting slot, an ending slot index and an ending symbol index within the ending slot.

In one or more implementations, if the indicated UL subband, DL subband, or overlapping subband are overlapping in one or more RBs or symbols, the UE 104 considers one or more predefined rules to derive the time and frequency domain allocations. For example, if a UL subband is overlapping with a DL subband, or vice-versa, the UE 104 assumes the overlapping RBs are the overlapping subband or excludes the overlapped RB resources of the DL subband (e.g., if the UL subband is indicated) or of the UL subband (e.g., if the DL subband is indicated). By way of another example, if a UL/DL subband is overlapping with an overlapping subband, or vice-versa, the UE 104 assumes the overlapping RBs are the overlapping subband, or excludes the overlapped resources of the overlapping subband, the DL subband, or the UL subband.

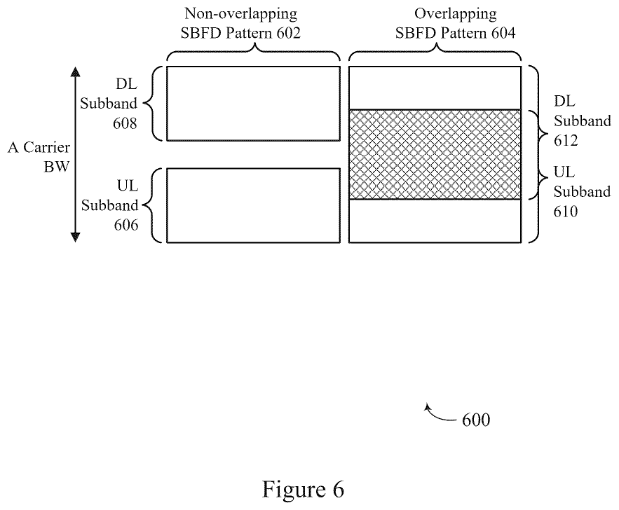

FIG. 6 illustrates an example 600 of multiple SBFD configurations in accordance with aspects of the present disclosure. In one or more implementations, the NE 102 indicates two SBFD configurations to the UE 104, e.g., one configuration with non-overlapping subbands and another configuration with overlapping (e.g., partial overlapping) subbands for joint DL and UL communications. For example, the UE 104 can receive an SBFD time-frequency resource configuration message, where the configuration message indicates two SBFD patterns.

The example 600 shows a non-overlapping SBFD pattern 602 and an overlapping SBFD pattern 604. The non-overlapping SBFD pattern 602 includes a UL subband 606 and a DL subband 608, which are non-overlapping subbands. The overlapping SBFD pattern 604 includes a UL subband 610 and a DL subband 612, which are overlapping subbands. The portion of the UL subband 610 and the DL subband 612 is illustrated with cross-hatching.

In one or more implementations, the UE 104 receives the configuration for the two SBFD patterns jointly, via, e.g., a cell-specific signaling (e.g., via SIB1). Additionally, or alternatively, the UE 104 may receive the configuration for one of the two SBFD patterns via a cell-specific signaling (e.g., via SIB1) and then receive the configuration for the other one of the two SBFD patterns via a group or UE-specific signaling.

In one or more implementations, the two SBFD patterns are non-overlapping in time domain. Additionally, or alternatively, the two patterns are fully or partially overlapping in time domain, where the frequency resources of the second SBFD pattern overrides (e.g., takes precedence over) the frequency resources of the first SBFD pattern, e.g., in all symbol types or only on a predefined symbol type (e.g., if symbol type is configured flexible by TDD-UL-DL-ConfigCommon, or if symbol type is configured X by SBFD-UL-DL-ConfigCommon). It should be noted that symbol types include X, DL, UL, and Flexible.

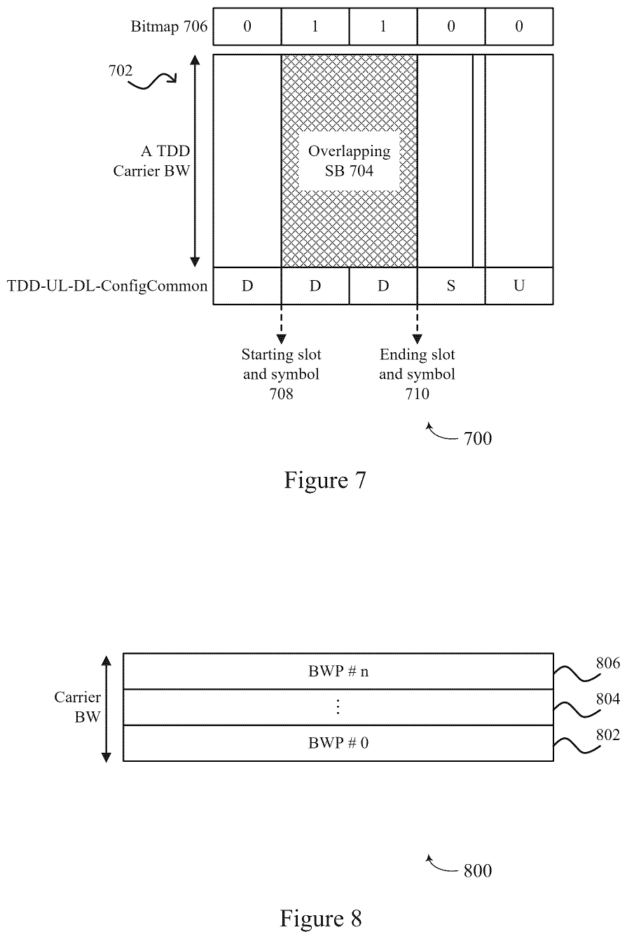

FIG. 7 illustrates an example 700 of an overlapping subband time resource configuration in accordance with aspects of the present disclosure. The example 700 illustrates a time domain bitmap or time configurations for indicating symbols/slots for joint DL and UL communications. The example 700 illustrates a DDDSU TDD slot configuration pattern 702 with an overlapping subband 704.

In one or more implementations, a UE 104 receives a full overlapping subband time resource configuration message, where the configuration message indicates the symbols/slots where all the associated frequency resources are used for joint DL and UL communications.

In one or more implementations, indication is in slot-granularity, where a ‘1’ in a bitmap 706 indicates a slot with full-overlapping frequency resources. The bitmap bit width is equal to the number of slots with a TDD pattern configured by, e.g., TDD-UL-DL-ConfigCommon.

Additionally, or alternatively, the indication is in symbol-granularity and the full overlapping subband time resource configuration message indicates symbols with full-overlapping frequency resources using a starting slot index and a starting symbol index 708 within the starting slot, and an ending slot index and an ending symbol index 710 within the ending slot.

FIG. 8 illustrates an example 800 of multiple bandwidth parts (BWPs) in accordance with aspects of the present disclosure. In one or more implementations, the configuration message is provided with or associated with a BWP (or a subband, or a frequency-region) of carrier bandwidth, as illustrated in example 800, where the configuration indicates indexes of associated BWP. For example, BWP 802 can include one or more overlapping subbands, BWP 804 can include one or more DL subbands, and BWP 806 can include one or more UL subbands. In one or more implementations, the configuration message includes configurations of at least the frequency domain location of each BWP. Additionally, or alternatively, frequency domain location of BWPs are provided separately in a separate configuration message.

Accordingly, returning to FIG. 1, an additional subband, referred to as an Overlapping subband or a shared subband, is indicated to be used for joint DL and UL communications. To provide improved location flexibility of the overlapping subband, different indication options are discussed, including a full flexibility approach where an overlapping subband pattern has its own time and frequency resources than non-overlapping SBFD pattern(s).

Furthermore, two SBFD configurations or patterns can be provided to a UE with the motivation of providing more flexibility to a network scheduler (e.g, a NE 102) to allocate the subband configurations while considering interference situations and users' needs.

Furthermore, a number of slots or symbols being converted to a full overlapping subband is discussed, where only the time domain configurations are provided to the UE, e.g., using a bitmap or using a slot or symbols indication.

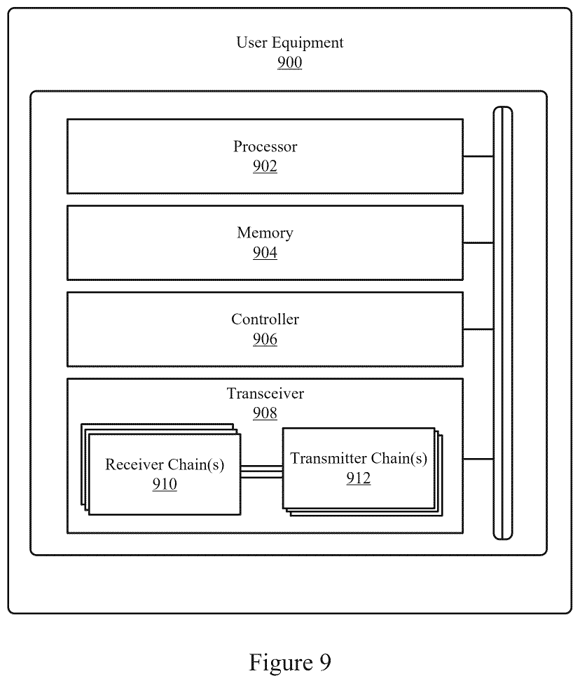

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving a configuration message that indicates a frequency resource for an overlapping subband in which UL and DL communications can occur over the frequency resource and a same time resource in which UL and DL communications can occur over the frequency resource and a same time resource; and concurrently transmitting a UL signal and receive a DL signal over the indicated frequency resource.

Additionally, the UE 900 may be configured to support any one or combination of where the configuration message indicates a time resource and a periodicity configuration for the overlapping subband, and concurrently transmitting the UL signal and receive the DL signal further comprises concurrently transmitting the UL signal and receive the DL signal over the indicated frequency resource at the indicated periodicity; where the configuration message indicates a first SBFD configuration using the indicated frequency resource, and the method further including: receiving a configuration message that indicates a second SBFD configuration; and receiving an indication to use the first SBFD configuration and the second SBFD configuration; where the configuration message indicates, using at least one of a bitmap or a slot and symbol indication, a time resource for the overlapping subband; where the configuration message is associated with a predefined configuration or a preconfigured configuration; further including deriving at least one of a time resource or a periodicity configuration for the overlapping subband from the predefined configuration or from the preconfigured configuration; where the configuration message indicates at least one of a time-frequency configuration for a UL non-overlapping subband for UL communications or a time-frequency configuration for a DL non-overlapping subband for DL communications; further including determining that one or more RBs of the DL non-overlapping subband that overlap one or more RBs of the UL non-overlapping subband are one or more RBs of the overlapping subband; further including determining that one or more RBs of the DL non-overlapping subband that overlap one or more RBs of the UL non-overlapping subband override the one or more RBs of the UL non-overlapping subband; further including determining that one or more RBs of the UL non-overlapping subband that overlap one or more RBs of the DL non-overlapping subband override the one or more RBs of the DL non-overlapping subband; where receiving the configuration message further comprises receiving the configuration message via at least one of a group-specific signaling or a UE-specific signaling; further including determining that one or more RBs of the overlapping subband override one or more RBs of a configured DL subband or a configured UL subband.

Additionally, or alternatively, the UE 900 may support at least one memory (e.g., the memory 904) and at least one processor (e.g., the processor 902) coupled with the at least one memory and configured to or operable to cause the UE to: receive a configuration message that indicates a frequency resource for an overlapping subband in which UL and DL communications can occur over the frequency resource and a same time resource; concurrently transmit a UL signal and receive a DL signal over the indicated frequency resource.

Additionally, the UE 900 may be configured to or operable to support any one or combination of where the configuration message indicates a time resource and a periodicity configuration for the overlapping subband, and to concurrently transmit the UL signal and receive the DL signal, and the at least one processor is further operable to cause the UE to concurrently transmit the UL signal and receive the DL signal over the indicated frequency resource at the indicated periodicity; where the configuration message indicates a first SBFD configuration using the indicated frequency resource, and the at least one processor is further operable to cause the UE to: receive a configuration message that indicates a second SBFD configuration; and receive an indication to use the first SBFD configuration and the second SBFD configuration; where the configuration message indicates, using at least one of a bitmap or a slot and symbol indication, a time resource for the overlapping subband; where the configuration message is associated with a predefined configuration or a preconfigured configuration; where the at least one processor is further operable to cause the UE to derive at least one of a time resource or a periodicity configuration for the overlapping subband from the predefined configuration or from the preconfigured configuration; where the configuration message indicates at least one of a time-frequency configuration for a UL non-overlapping subband for UL communications or a time-frequency configuration for a DL non-overlapping subband for DL communications; where the at least one processor is further operable to cause the UE to determine that one or more RBs of the DL non-overlapping subband that overlap one or more RBs of the UL non-overlapping subband are one or more RBs of the overlapping subband; where the at least one processor is further operable to cause the UE to determine that one or more RBs of the DL non-overlapping subband that overlap one or more RBs of the UL non-overlapping subband override the one or more RBs of the UL non-overlapping subband; where the at least one processor is further operable to cause the UE to determine that one or more RBs of the UL non-overlapping subband that overlap one or more RBs of the DL non-overlapping subband override the one or more RBs of the DL non-overlapping subband; where to receive the configuration message, the at least one processor is further operable to cause the UE to receive the configuration message via at least one of a group-specific signaling or a UE-specific signaling; where the at least one processor is further operable to cause the UE to determine that one or more RBs of the overlapping subband override one or more RBs of a configured DL subband or a configured UL subband.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

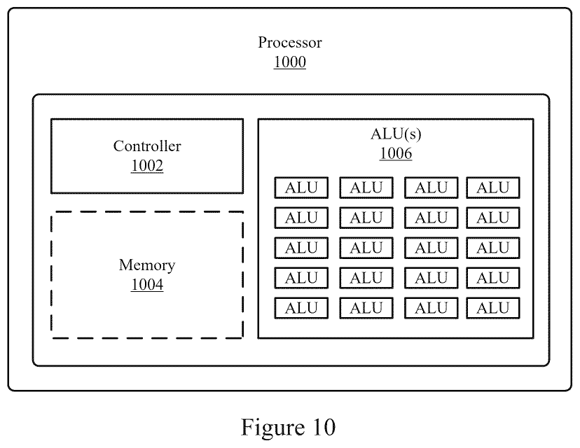

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to: receive a configuration message that indicates a frequency resource for an overlapping subband in which UL and DL communications can occur over the frequency resource and a same time resource; concurrently transmit a UL signal and receive a DL signal over the indicated frequency resource.

Additionally, the processor 1000 may be configured to or operable to support any one or combination of where the configuration message indicates a time resource and a periodicity configuration for the overlapping subband, and to concurrently transmit the UL signal and receive the DL signal, the at least one controller is further operable to cause the processor to concurrently transmit the UL signal and receive the DL signal over the indicated frequency resource at the indicated periodicity; where the configuration message indicates a first SBFD configuration using the indicated frequency resource, and the at least one controller is further operable to cause the processor to: receive a configuration message that indicates a second SBFD configuration; and receive an indication to use the first SBFD configuration and the second SBFD configuration; where the configuration message indicates, using at least one of a bitmap or a slot and symbol indication, a time resource for the overlapping subband; where the configuration message is associated with a predefined configuration or a preconfigured configuration; where the at least one controller is further operable to cause the processor to derive at least one of a time resource or a periodicity configuration for the overlapping subband from the predefined configuration or from the preconfigured configuration; where the configuration message indicates at least one of a time-frequency configuration for a UL non-overlapping subband for UL communications or a time-frequency configuration for a DL non-overlapping subband for DL communications; where the at least one controller is further operable to cause the processor to determine that one or more RBs of the DL non-overlapping subband that overlap one or more RBs of the UL non-overlapping subband are one or more RBs of the overlapping subband; where the at least one controller is further operable to cause the processor to determine that one or more RBs of the DL non-overlapping subband that overlap one or more RBs of the UL non-overlapping subband override the one or more RBs of the UL non-overlapping subband; where the at least one controller is further operable to cause the processor to determine that one or more RBs of the UL non-overlapping subband that overlap one or more RBs of the DL non-overlapping subband override the one or more RBs of the DL non-overlapping subband; where to receive the configuration message, the at least one controller is further operable to cause the processor to receive the configuration message via at least one of a group-specific signaling or a UE-specific signaling; where the at least one controller is further operable to cause the processor to determine that one or more RBs of the overlapping subband override one or more RBs of a configured DL subband or a configured UL subband.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to: transmit a configuration message that indicates a frequency resource for an overlapping subband in which UL and DL communications can occur over the frequency resource and a same time resource; concurrently receive a UL signal and transmit a DL signal over the indicated frequency resource.

Additionally, the processor 1000 may be configured to or operable to support any one or combination of where the configuration message indicates a time resource and a periodicity configuration for the overlapping subband, and to concurrently receive the UL signal and transmit the DL signal, the at least one controller is further operable to cause the processor to concurrently receive the UL signal and transmit the DL signal over the indicated frequency resource at the indicated periodicity; where the configuration message indicates a first SBFD configuration using the indicated frequency resource, and the at least one controller is further operable to cause the processor to: transmit a configuration message that indicates a second SBFD configuration; and transmit an indication to use the first SBFD configuration and the second SBFD configuration; where the configuration message indicates, using at least one of a bitmap or a slot and symbol indication, a time resource for the overlapping subband; where the configuration message is associated with a predefined configuration or a preconfigured configuration; where the configuration message indicates at least one of a time-frequency configuration for a UL non-overlapping subband for UL communications or a time-frequency configuration for a DL non-overlapping subband for DL communications; where one or more RBs of the DL non-overlapping subband that overlap one or more RBs of the UL non-overlapping subband are one or more RBs of the overlapping subband; where one or more RBs of the DL non-overlapping subband that overlap one or more RBs of the UL non-overlapping subband override the one or more RBs of the UL non-overlapping subband; where one or more RBs of the UL non-overlapping subband that overlap one or more RBs of the DL non-overlapping subband override the one or more RBs of the DL non-overlapping subband; where to transmit the configuration message, the at least one controller is further operable to cause the processor to transmit the configuration message via at least one of a group-specific signaling or a UE-specific signaling; where one or more RBs of the overlapping subband override one or more RBs of a configured DL subband or a configured UL subband.

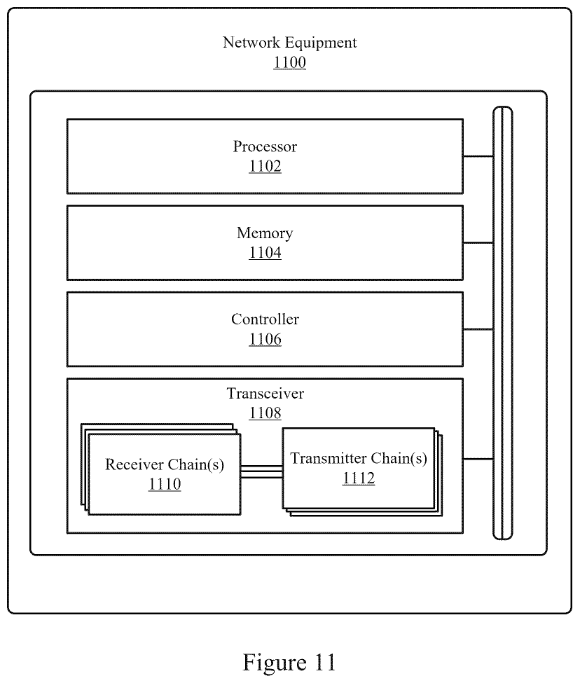

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to support a means for transmitting a configuration message that indicates a frequency resource for an overlapping subband in which UL and DL communications can occur over the frequency resource and a same time resource; concurrently receiving a UL signal and transmit a DL signal over the indicated frequency resource.

Additionally, the NE 1100 may be configured to support any one or combination of where the configuration message indicates, using at least one of a bitmap or a slot and symbol indication, a time resource for the overlapping subband; where the configuration message is associated with a predefined configuration or a preconfigured configuration; where the configuration message indicates at least one of a time-frequency configuration for a UL non-overlapping subband for UL communications or a time-frequency configuration for a DL non-overlapping subband for DL communications; where one or more RBs of the DL non-overlapping subband that overlap one or more RBs of the UL non-overlapping subband are one or more RBs of the overlapping subband; where one or more RBs of the DL non-overlapping subband that overlap one or more RBs of the UL non-overlapping subband override the one or more RBs of the UL non-overlapping subband; where one or more RBs of the UL non-overlapping subband that overlap one or more RBs of the DL non-overlapping subband override the one or more RBs of the DL non-overlapping subband; where transmitting the configuration message further comprises transmitting the configuration message via at least one of a group-specific signaling or a UE-specific signaling; where one or more RBs of the overlapping subband override one or more RBs of a configured DL subband or a configured UL subband.

Additionally, or alternatively, the NE 1100 may support at least one memory (e.g., the memory 1104) and at least one processor (e.g., the processor 1102) coupled with the at least one memory and configured to cause the NE to: transmit a configuration message that indicates a frequency resource for an overlapping subband in which UL and DL communications can occur over the frequency resource and a same time resource; concurrently receive a UL signal and transmit a DL signal over the indicated frequency resource.

Additionally, the NE 1100 may be configured to support any one or combination of where the configuration message indicates a time resource and a periodicity configuration for the overlapping subband, and to concurrently receive the UL signal and transmit the DL signal, the at least one processor is further operable to cause the NE to concurrently receive the UL signal and transmit the DL signal over the indicated frequency resource at the indicated periodicity; where the configuration message indicates a first SBFD configuration using the indicated frequency resource, and the at least one processor is further operable to cause the NE to: transmit a configuration message that indicates a second SBFD configuration; and transmit an indication to use the first SBFD configuration and the second SBFD configuration; where the configuration message indicates, using at least one of a bitmap or a slot and symbol indication, a time resource for the overlapping subband; where the configuration message is associated with a predefined configuration or a preconfigured configuration; where the configuration message indicates at least one of a time-frequency configuration for a UL non-overlapping subband for UL communications or a time-frequency configuration for a DL non-overlapping subband for DL communications; where one or more RBs of the DL non-overlapping subband that overlap one or more RBs of the UL non-overlapping subband are one or more RBs of the overlapping subband; where one or more RBs of the DL non-overlapping subband that overlap one or more RBs of the UL non-overlapping subband override the one or more RBs of the UL non-overlapping subband; where one or more RBs of the UL non-overlapping subband that overlap one or more RBs of the DL non-overlapping subband override the one or more RBs of the DL non-overlapping subband; where to transmit the configuration message, the at least one processor is further operable to cause the NE to transmit the configuration message via at least one of a group-specific signaling or a UE-specific signaling; where one or more RBs of the overlapping subband override one or more RBs of a configured DL subband or a configured UL subband.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

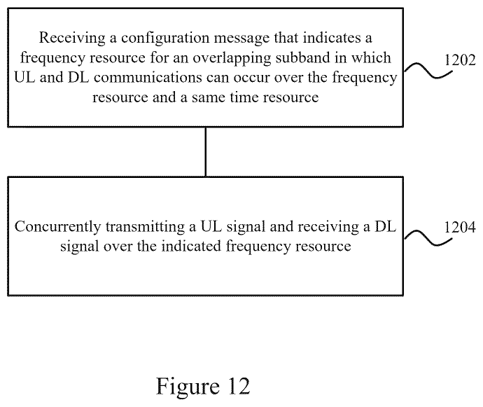

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may include receiving a configuration message that indicates a frequency resource for an overlapping subband in which UL and DL communications can occur over the frequency resource and a same time resource. The operations of 1202 may be performed in accordance with examples as described herein. In some implementations, aspects of the operations of 1202 may be performed by a UE as described with reference to FIG. 9.

At 1204, the method may include concurrently transmitting a UL signal and receiving a DL signal over the indicated frequency resource. The operations of 1204 may be performed in accordance with examples as described herein. In some implementations, aspects of the operations of 1204 may be performed by a UE as described with reference to FIG. 9.

It should be noted that the method described herein describes a possible implementation, and that the operations and the steps may be rearranged or otherwise modified and that other implementations are possible.

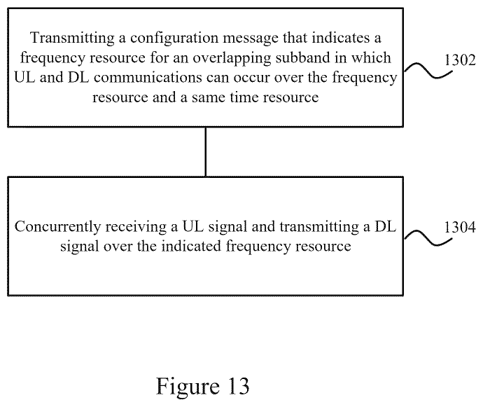

FIG. 13 illustrates a flowchart of a method in accordance with aspects of the present disclosure. The operations of the method may be implemented by an NE as described herein. In some implementations, the NE may execute a set of instructions to control the function elements of the NE to perform the described functions.

At 1302, the method may include transmitting a configuration message that indicates a frequency resource for an overlapping subband in which UL and DL communications can occur over the frequency resource and a same time resource. The operations of 1302 may be performed in accordance with examples as described herein. In some implementations, aspects of the operations of 1302 may be performed by an NE as described with reference to FIG. 11.

At 1304, the method may include concurrently receiving a UL signal and transmitting a DL signal over the indicated frequency resource. The operations of 1304 may be performed in accordance with examples as described herein. In some implementations, aspects of the operations of 1304 may be performed by an NE as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a configuration message that indicates a frequency resource for an overlapping subband in which uplink (UL) and downlink (DL) communications can occur over the frequency resource and a same time resource;
concurrently transmit a UL signal and receive a DL signal over the indicated frequency resource.

2. The UE of claim 1, wherein the configuration message indicates a time resource and a periodicity configuration for the overlapping subband, and to concurrently transmit the UL signal and receive the DL signal, and the at least one processor is further operable to cause the UE to concurrently transmit the UL signal and receive the DL signal over the indicated frequency resource at the indicated periodicity.

3. The UE of claim 1, wherein the configuration message indicates a first subband full duplex (SBFD) configuration using the indicated frequency resource, and the at least one processor is further operable to cause the UE to:
receive a configuration message that indicates a second SBFD configuration; and
receive an indication to use the first SBFD configuration and the second SBFD configuration.

4. The UE of claim 1, wherein the configuration message indicates, using at least one of a bitmap or a slot and symbol indication, a time resource for the overlapping subband.

5. The UE of claim 1, wherein the configuration message is associated with a predefined configuration or a preconfigured configuration.

6. The UE of claim 5, wherein the at least one processor is further operable to cause the UE to derive at least one of a time resource or a periodicity configuration for the overlapping subband from the predefined configuration or from the preconfigured configuration.

7. The UE of claim 1, wherein the configuration message indicates at least one of a time-frequency configuration for a UL non-overlapping subband for UL communications or a time-frequency configuration for a DL non-overlapping subband for DL communications.

8. The UE of claim 7, wherein the at least one processor is further operable to cause the UE to determine that one or more resource blocks (RBs) of the DL non-overlapping subband that overlap one or more RBs of the UL non-overlapping subband are one or more RBs of the overlapping subband.

9. The UE of claim 7, wherein the at least one processor is further operable to cause the UE to determine that one or more resource blocks (RBs) of the DL non-overlapping subband that overlap one or more RBs of the UL non-overlapping subband override the one or more RBs of the UL non-overlapping subband.

10. The UE of claim 7, wherein the at least one processor is further operable to cause the UE to determine that one or more resource blocks (RBs) of the UL non-overlapping subband that overlap one or more RBs of the DL non-overlapping subband override the one or more RBs of the DL non-overlapping subband.

11. The UE of claim 1, wherein to receive the configuration message, the at least one processor is further operable to cause the UE to receive the configuration message via at least one of a group-specific signaling or a UE-specific signaling.

12. The UE of claim 1, wherein the at least one processor is further operable to cause the UE to determine that one or more resource blocks (RBs) of the overlapping subband override one or more RBs of a configured DL subband or a configured UL subband.

13. A network equipment (NE) for wireless communication, comprising:
at least one memory; and
at least one processor coupled with the at least one memory and operable to cause the NE to:
transmit a configuration message that indicates a frequency resource for an overlapping subband in which uplink (UL) and downlink (DL) communications can occur over the frequency resource and a same time resource;
concurrently receive a UL signal and transmit a DL signal over the indicated frequency resource.

14. The NE of claim 13, wherein the configuration message indicates a time resource and a periodicity configuration for the overlapping subband, and to concurrently receive the UL signal and transmit the DL signal, the at least one processor is further operable to cause the NE to concurrently receive the UL signal and transmit the DL signal over the indicated frequency resource at the indicated periodicity.

15. The NE of claim 13, wherein the configuration message indicates a first subband full duplex (SBFD) configuration using the indicated frequency resource, and the at least one processor is further operable to cause the NE to:
transmit a configuration message that indicates a second SBFD configuration; and
transmit an indication to use the first SBFD configuration and the second SBFD configuration.

16. The NE of claim 13, wherein the configuration message indicates, using at least one of a bitmap or a slot and symbol indication, a time resource for the overlapping subband.

17. The NE of claim 13, wherein the configuration message is associated with a predefined configuration or a preconfigured configuration.

18. The NE of claim 13, wherein the configuration message indicates at least one of a time-frequency configuration for a UL non-overlapping subband for UL communications or a time-frequency configuration for a DL non-overlapping subband for DL communications.

19. A method performed by a user equipment (UE), the method comprising:
receiving a configuration message that indicates a frequency resource for an overlapping subband in which uplink (UL) and downlink (DL) communications can occur over the frequency resource and a same time resource; and
concurrently transmitting a UL signal and receiving a DL signal over the indicated frequency resource.

20. A method performed by a network equipment (NE), the method comprising:
transmitting a configuration message that indicates a frequency resource for an overlapping subband in which uplink (UL) and downlink (DL) communications can occur over the frequency resource and a same time resource; and
concurrently receiving a UL signal and transmitting a DL signal over the indicated frequency resource.
